(19) United States
(12) Patent Application Publication
(10) Pub. No.: US 2013/0018562 A1
(43) Pub. Date: Jan. 17, 2013

(54) VEHICLE CONTROL DEVICE

(71) Applicants: Koji Nakai, Susono-shi (JP); Takashi Suzuki, Susono-shi (JP)

(72) Inventors: Koji Nakai, Susono-shi (JP); Takashi Suzuki, Susono-shi (JP)

(73) Assignee: TOYOTA JIDOSHA KABUSHIKI KAISHA, Toyota-shi (JP)

(21) Appl. No.: 13/637,898

(22) PCT Filed: Mar. 29, 2010
(86) PCT No.: PCT/JP10/55565

§ 371 Date: Sep. 27, 2012

(51) Int. Cl. G05D 13/00

(52) U.S. Cl. 701/93

(57) ABSTRACT

A problem is to provide a vehicle control device, which performs travel control prepared for an unforeseen event by setting a tire friction circle to be small on a site on a road on which it is highly possible that the unforeseen event is found with delay due to a curve and poor visibility. An ECU sets a target speed with a predetermined allowance for a limit speed which is an upper limit speed of the vehicle, at a point at which a risk cannot be expected easily on a path along which the vehicle travels and generates a planned speed pattern which is a speed pattern of the path, based on the limit speed and the target speed.

### FIELD

The present invention relates to a vehicle control device.

### BACKGROUND

Technology to perform travel control of a vehicle based on a travel plan is conventionally developed.

For example, Patent Literature 1 discloses technology to perform the travel control of the vehicle based on the travel plan including a deceleration section in which the vehicle is decelerated by stopping an internal combustion engine of the vehicle and sets again the travel plan in consideration of fuel consumption even when a non-stop state of the internal combustion engine occurs.

Patent Literature 2 discloses technology to provide travel information matching with a detailed road condition to a driver by calculating a recommended speed of the vehicle based on a road shape and traffic information and correcting the recommended speed according to a road condition around a specific point at which the recommended speed changes.

Patent Literature 3 discloses technology to perform the travel control within an appropriate vehicle speed determined based on a curvature radius of a curve and allowable lateral acceleration which the vehicle receives, in consideration of a sense of safety of the driver during travel on the curve of the vehicle, the technology to execute the travel control to decelerate especially on the curve with poor visibility.

Patent Literature 4 discloses technology to calculate the appropriate vehicle speed at the time of entrance to the curve from the curvature of the curve and predicts alert timing such that the vehicle speed may be decreased a predetermined distance before the curve when the vehicle speed of the vehicle, which travels, is higher than the appropriate vehicle speed to alert the driver without providing a sense of discomfort, the technology to advance the timing of the alert of deceleration especially on the curve with poor visibility.

Patent Literature 5 discloses technology to alert the driver or decelerate the vehicle by controlling an actuator according to a situation in front of the vehicle when the speed of the vehicle is higher than a target vehicle speed and it is judged that the driver does not have intention of decelerating, the technology to control such that the deceleration is larger even at a low vehicle speed especially in an environment with poor visibility such as on a blind curve.

Patent Literature 6 discloses technology to detect the curve in front of the vehicle and perform deceleration control by issuing the alert to the driver or performing engine output control of the vehicle in a case in which the curve is the blind curve with poor visibility and it is judged that the speed of the vehicle is too high.

### CITATION LIST

### Patent Literature

Patent Literature 1: Japanese Patent Application Laid-open No. 2009-257124

Patent Literature 2: Japanese Patent Application Laid-open No. 2006-163942

Patent Literature 3: Japanese Patent Application Laid-open No. 2009-179251

Patent Literature 4: Japanese Patent Application Laid-open No. 2002-163786

Patent Literature 5: Japanese Patent Application Laid-open No. H11-148394

Patent Literature 6: Japanese Patent Application Laid-open No. H08-194895

### SUMMARY

### Technical Problem

However, in the conventional vehicle control device disclosed in Patent Literatures 1 to 6, when a limit speed on the curve is set, although traffic information is used or control to inhibit intervention of the driver is performed, this is basically set based on static information such as the road shape used in a car navigation system and the like. Therefore, in the conventional vehicle control device, although the static information is utilized as anticipatory information of the front of the vehicle, there is a problem that dynamic information about an event occurring on a road by road surface freezing, an obstacle such as a burden fallen from a loading platform of a truck and the like are not taken into consideration. That is to say, the conventional vehicle control device has a problem that the driver does not have much leeway in driving due to delay in dealing with an unforeseen event when the vehicle travels at a point with a high risk in which it is highly possible that the unforeseen event is found with delay (winding curve, curve with poor visibility and the like).

Although the conventional vehicle control device sets the limit speed based on the static information such as the road shape, variation in travel pace for each driver and the like is not taken into consideration, so that this also has a problem that there is a driver who feels a sense of discomfort when dealing with the unforeseen event.

The present invention is achieved in view of the above-described circumstances and an object thereof is to provide the vehicle control device, which performs the travel control prepared for the unforeseen event by setting a tire friction circle to be small on a site on the road at which it is highly possible that the unforeseen event is found with delay due to the curve and the poor visibility.

### Solution to Problem

A vehicle control device according to the present invention includes a target speed setting means configured to set a target speed with a predetermined allowance for a limit speed which is an upper limit speed of a vehicle, at a point at which a risk is not expected easily on a path along which the vehicle travels; and a planned speed pattern generating means configured to generate a planned speed pattern which is a speed pattern of the path, based on the limit speed and the target speed.

Further, it is preferable that the target speed setting means sets the target speed with the allowance smaller than the predetermined allowance for the limit speed when an absolute value of the limit speed at the point is smaller than a predetermined value.

### Advantageous Effects of Invention

According to the present invention, at the point at which the risk cannot be expected easily on the path along which the vehicle travels, the target speed with the predetermined allowance for the limit speed, which is the upper limit speed of the vehicle, is set and the planned speed pattern, which is the speed pattern of the path, is generated based on the limit speed and the target speed, so that there is an effect that tire force capable of dealing with the unforeseen event due to the road surface freezing, presence of the fallen object and the like can be reserved by setting a margin of the tire force and the like large at the point at which the dynamic risk is high.

Also, according to the present invention, when the absolute value of the limit speed is smaller than the predetermined value at the point at which the risk cannot be expected easily on the path along which the vehicle travels, the target speed with the allowance smaller than the predetermined allowance for the limit speed is set, so that there is an effect that a sense of discomfort generated by setting the large margin can be eliminated when the travel at slow pace is required.

### BRIEF DESCRIPTION OF DRAWINGS

FIG. 1 is a block diagram illustrating a configuration of an ECU in this embodiment.

FIG. 2 is a flowchart illustrating an example of a travel plan creating process in this embodiment.

FIG. 3 is a view illustrating an example of relationship between a curvature of a road and tire reserve strength in this embodiment.

FIG. 4 is a view illustrating an example of relationship between the tire reserve strength and a friction circle in this embodiment.

FIG. 5 is a view illustrating an example of a tire reserve strength pattern on a path along which a vehicle travels in this embodiment.

FIG. 6 is a view illustrating an example of a planned travel line on the path along which the vehicle travels in this embodiment.

FIG. 7 is a view illustrating an example of a planned speed pattern on a curve on the path along which the vehicle travels in this embodiment.

FIG. 8 is a view illustrating an example of a planned acceleration/deceleration pattern on the curve on the path along which the vehicle travels in this embodiment.

FIG. 9 is a view illustrating an example of a planned tire reserve strength pattern on the path along which the vehicle travels in this embodiment.

### DESCRIPTION OF EMBODIMENTS

Hereinafter, an embodiment of a vehicle control device according to the present invention is described in detail with reference to the drawings. Meanwhile, the invention is not limited by the embodiment.

### 1. Configuration

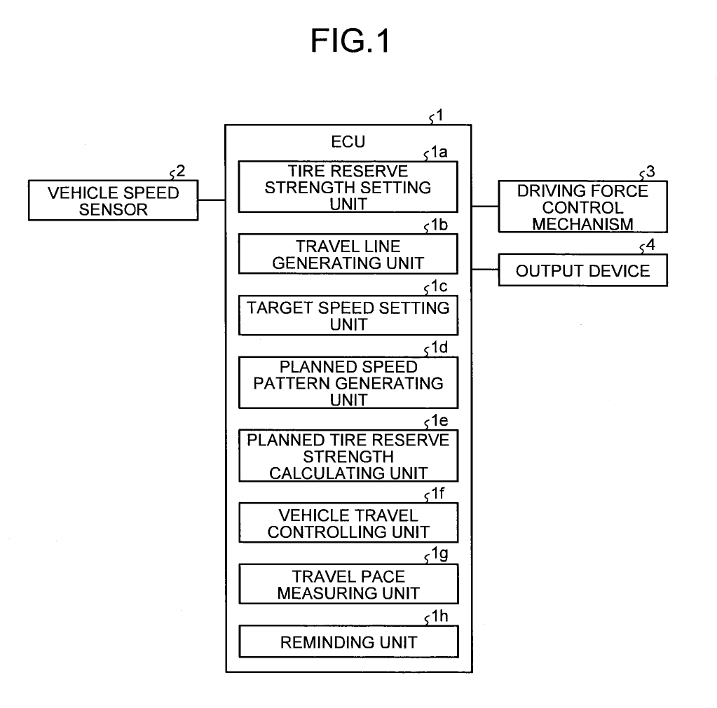

A configuration of an ECU (electronic control unit) of this embodiment is described with reference to FIG. 1. FIG. 1 is a block diagram illustrating the configuration of the ECU of this embodiment.

In FIG. 1, a reference numeral 1 represents the ECU (including the vehicle control device according to the present invention) installed in a vehicle of which driving force and the like can be controlled, a reference numeral 2 represents a vehicle speed sensor, a reference numeral 3 represents a driving force control mechanism, which controls the driving force of the vehicle, and a reference numeral 4 represents an output device. In FIG. 1, a reference numeral 1a represents a tire reserve strength setting unit, a reference numeral 1b represents a travel line generating unit, a reference numeral 1c represents a target speed setting unit, a reference numeral 1d represents a planned speed pattern generating unit, a reference numeral 1e represents a planned tire reserve strength calculating unit, a reference numeral 1f represents a vehicle travel controlling unit, a reference numeral 1g represents a travel pace measuring unit, and a reference numeral 1h represents a reminding unit.

The tire reserve strength setting unit 1a sets tire reserve strength at a point on a path along which the vehicle travels based on possibility that an unforeseen event is found with delay. Herein, the tire reserve strength may be a ratio of a value obtained by subtracting frictional force of a tire required at the time of travel from a limit value of the frictional force of the tire (that is to say, an outer periphery of a friction circle) to the limit value. The tire reserve strength setting unit 1a may also set the tire reserve strength at the point on the path along which the vehicle travels based on the possibility that the unforeseen event is found with delay set by using a curvature of a road based on map data (for example, the map data and the like including road shape data of a road on a map used in a car navigation system and the like) stored in the vehicle in advance. The tire reserve strength setting unit la may also set the tire reserve strength at the point on the path along which the vehicle travels by using a travel pace friction circle, which is an average of the friction circle of the tire based on travel pace of a driver obtained by the ECU 1.

The travel line generating unit 1b generates a target track (planned travel line), which is the track in the path (within a road width) along which the vehicle travels. Herein, the travel line generating unit 1b may generate the planned travel line, which is the track in the path along which the vehicle travels, based on the track stored in the vehicle in advance. The travel line generating unit 1b may generate the planned travel line, which is the track passing through a center of a lane in the path along which the vehicle travels. The travel line generating unit 1b may also generate the planned travel line, which is the track to realize out-in-out on a curve in the path along which the vehicle travels and is the track passing through the center of the lane outside the curve. Herein, the out-in-out is the track passing outside the center of the lane on an entrance of the curve, passing inside the center of the lane in an intermediate portion of the curve, and passing outside the center of the lane on an exit of the curve.

The target speed setting unit 1c sets a target speed with a predetermined allowance for a limit speed, which is an upper limit speed of the vehicle, at a point at which a risk cannot be expected easily on the path along which the vehicle travels. Herein, the target speed setting unit 1c may set the target speed with the allowance for the limit speed such that the friction circle of the tire becomes small at the point at which it is highly possible that the unforeseen event might be found with delay on the path along which the vehicle travels (point with a curve, point with poor visibility and the like). The target speed setting unit 1c may also set the target speed with the allowance smaller than the predetermined allowance for the limit speed when an absolute value of the limit speed at the point at which the risk cannot be expected easily on the path along which the vehicle travels is smaller than a predetermined value. The target speed setting unit 1c may also set the target speed with the allowance smaller than the predetermined allowance for the limit speed when the friction circle of the tire at the point at which the risk cannot be expected easily on the path along which the vehicle travels is smaller than a predetermined value. The target speed setting unit 1c may also set the target speed at the point at which the risk cannot be expected easily on the path along which the vehicle travels by using the limit speed stored in the vehicle in advance. Herein, the limit speed may be a speed, which satisfies a part or all of a speed set so as not to exceed a limit of the friction circle of the tire, which becomes smaller as the curvature of the road becomes larger, a speed, which may be realized by an actuator for operating a brake, an engine, and a transmission, and a legal speed at the point on the path along which the vehicle travels. The predetermined allowance may also be set based on the tire reserve strength set by the tire reserve strength setting unit 1a.

The planned speed pattern generating unit 1d generates a planned speed pattern, which is a speed pattern of the path, based on a planned speed based on the limit speed and the target speed. Herein, the planned speed pattern generating unit 1d may further generate a planned acceleration/deceleration pattern based on planned acceleration/deceleration, which is acceleration/deceleration calculated from the planned speed. Herein, as the planned speed, the target speed may be adopted at the point on the path at which the target speed is set and the limit speed may be adopted at the point other than this point.

Herein, the planned speed pattern generating unit 1d may further generate the planned acceleration/deceleration pattern using free running (sliding) for improving fuel efficiency. Herein, the free running is a mode of traveling by repeatedly turning on/off the engine not only in a hybrid system and is travel to accumulate motion energy (such as speed energy) when the engine is turned on and use the motion energy to allow the vehicle to move forward when the engine is turned off. The planned speed pattern generating unit 1d may further generate the planned speed pattern using the free running by determining timing of on/off of the engine and an output when the engine is turned on so as to be able to realize the upper limit speed in a position in which it should be decelerated (red signal, temporary stop, curve, traffic jam and the like) on the path obtained in advance without braking as far as possible. According to this, energy loss by braking decreases and energy consumption required for movement can be decreased. The planned speed pattern generating unit 1d may further generate the planned acceleration/deceleration pattern based on the planned speed not only on a next curve but also on a curve in front of this curve, that is to say, on a plurality of curves in front. According to this, it becomes possible to decrease unnecessary acceleration and braking.

The planned tire reserve strength calculating unit 1e calculates the tire reserve strength based on the planned speed, the planned acceleration/deceleration, and the curvature of the planned travel line (planned curvature) as planned tire reserve strength at the point on the path along which the vehicle travels.

The vehicle travel controlling unit if controls the driving force control mechanism 3, thereby allowing the vehicle to travel on the target track (planned travel line) generated by the travel line generating unit 1b according to the planned speed pattern and the planned acceleration/deceleration pattern generated by the planned speed pattern generating unit 1d, and the planned tire reserve strength calculated by the planned tire reserve strength calculating unit 1e. Herein, when the vehicle travel controlling unit if allows the vehicle to travel according to the planned speed pattern using the free running, this may control the driving force control mechanism 3 to disengage an engine output shaft from a drive wheel at a clutch, a planetary gear and the like for decreasing friction loss when the engine is turned off. When the vehicle travel controlling unit if allows the vehicle to travel according to the planned speed pattern using the free running, this may change a waveform (amplitude, center of amplitude, period and the like) of the planned speed pattern by controlling the output when the engine is turned on by controlling the driving force control mechanism 3.

The travel pace measuring unit 1g measures the travel pace of the driver at the time of travel of the vehicle and obtains an average of the friction circle of the tire based on the travel pace as the travel pace friction circle at the point on the path along which the vehicle travels. The travel pace measuring unit 1g may also measure the travel pace of the driver at the time of travel of the vehicle based on a vehicle speed detected by the vehicle speed sensor 2.

The reminding unit 1h reminds the driver to decelerate when the vehicle speed is higher than the planned speed on the path along which the vehicle travels. Herein, the reminding unit 1h may remind the driver to decelerate through the output device 4 when the vehicle speed detected by the vehicle speed sensor 2 is higher than the planned speed on the path along which the vehicle travels. The reminding unit 1h may also remind the driver to decelerate by outputting sound output data through the output device 4. The reminding unit 1h may also remind the driver to decelerate by outputting display output data through the output device 4.

### 2. Operation

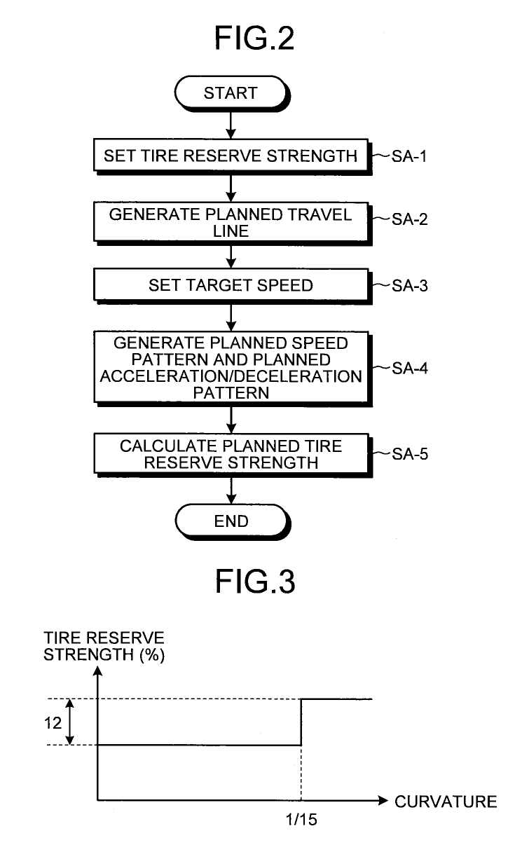

Next, an example of a travel plan creating process performed by the ECU 1 having the above-described configuration is described with reference to FIGS. 2 to 9. FIG. 2 is a flowchart illustrating an example of the travel plan creating process in this embodiment.

As illustrated in FIG. 2, the tire reserve strength setting unit la sets the tire reserve strength (%) at the point on the path along which the vehicle travels based on the possibility that the unforeseen event is found with delay set by using the curvature of the road and the like included in the road shape data stored in the vehicle in advance (step SA-1). Herein, the tire reserve strength setting unit 1a may also set the tire reserve strength at the point on the path along which the vehicle travels by using the travel pace friction circle, which is the average of the friction circle of the tire based on the travel pace of the driver obtained by the travel pace measuring unit 1g.

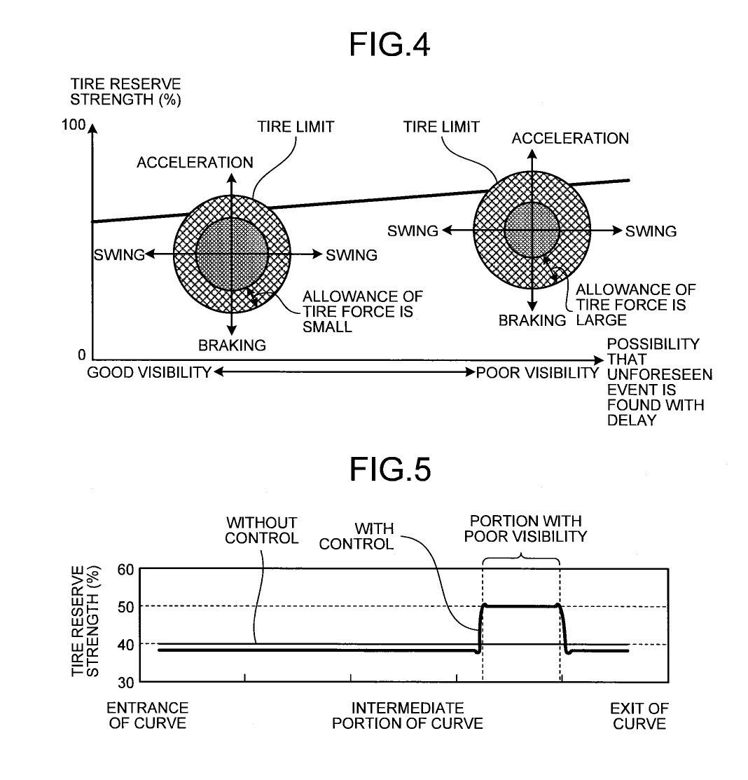

Herein, an example of the tire reserve strength in this embodiment is described with reference to FIGS. 3 to 5. FIG. 3 is a view illustrating an example of relationship between the curvature of the road and the tire reserve strength in this embodiment. FIG. 4 is a view illustrating an example of relationship between the tire reserve strength and the friction circle in this embodiment. FIG. 5 is a view illustrating an example of the tire reserve strength pattern on the path along which the vehicle travels in this embodiment.

As illustrated in FIG. 3, the tire reserve strength setting unit 1a applies the curvature of the road as a parameter of the possibility that the unforeseen event is found with delay and sets to increase the tire reserve strength by 12% when the curvature is not smaller than 1/15.

As illustrated in FIG. 4, the tire reserve strength setting unit la sets the tire reserve strength so as to sequentially change according to the possibility that the unforeseen event is found with delay. That is to say, at a point with good visibility at which the unforeseen event can be found early, the tire reserve strength setting unit 1a provides a small allowance of tire force for the outer periphery of the friction circle indicating a grip limit of the tire (tire limit), makes a circle therein the friction circle used for the travel plan, and sets the tire reserve strength at this point based on the friction circle. On the other hand, at the point with poor visibility at which the unforeseen event in which sudden steering and sudden braking are required is found with delay, the tire reserve strength setting unit 1a provides a large allowance of the tire force for the tire limit, makes a circle therein the friction circle used for the travel plan, and sets the tire reserve strength at this point based on the friction circle.

As illustrated in FIG. 5, the tire reserve strength (with control) set by the tire reserve strength setting unit 1a at each point on the path along which the vehicle travels is illustrated as the tire reserve strength pattern. That is to say, the tire reserve strength with control is set to be larger than the tire reserve strength (without control) at the time of travel at the limit speed in a portion with poor visibility and is set to be smaller than that without control in a portion with good visibility.

With reference to FIG. 2 again, the travel line generating unit 1b generates the planned travel line, which is the track in the path (within the road width) along which the vehicle travels based on the track stored in the vehicle in advance (step SA-2). Herein, the travel line generating unit 1b may generate the planned travel line, which is the track passing through the center of the lane in the path along which the vehicle travels. The travel line generating unit 1b may also generate the planned travel line, which is the track to realize the out-in-out on the curve in the path along which the vehicle travels and is the track passing through the center of the lane outside the curve.

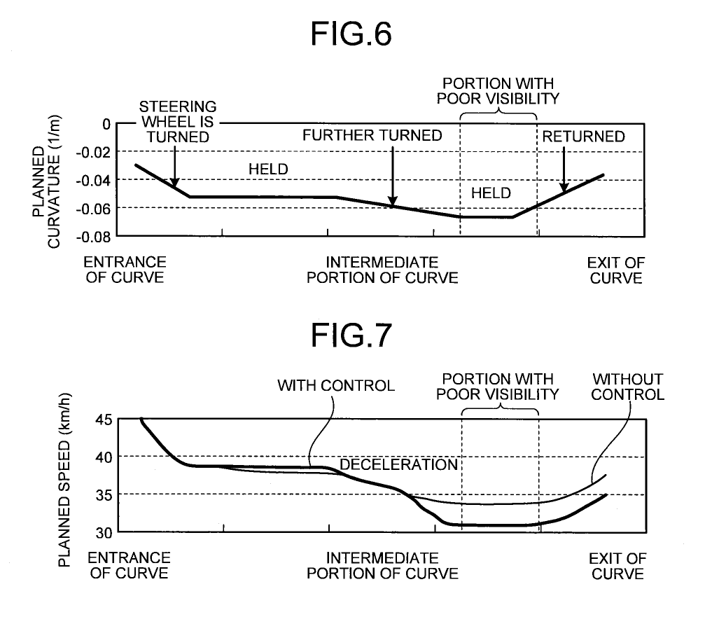

Herein, an example of the planned travel line on the path along which the vehicle travels in this embodiment is described with reference to FIG. 6. FIG. 6 is a view illustrating an example of the planned travel line on the path along which the vehicle travels in this embodiment.

As illustrated in FIG. 6, the travel line generating unit 1b generates the planned travel line (track on which a steering wheel is turned, held, further turned, held, and returned in the order of travel), which is the track with the curvature (planned curvature K) (1/m) with which drivability is not damaged at each point on the path, on the path along which the vehicle travels based on the track stored in the vehicle in advance.

With reference to FIG. 2 again, the target speed setting unit 1c sets the target speed with the allowance for the limit speed stored in the vehicle in advance such that the friction circle of the tire becomes smaller based on the tire reserve strength set by the tire reserve strength setting unit la in the portion with poor visibility at the point at which the risk cannot be expected easily on the path along which the vehicle travels (step SA-3). Herein, the target speed setting unit 1c may set the target speed with the allowance smaller than the predetermined allowance for the limit speed when the absolute value of the limit speed at the point at which the risk cannot be expected easily on the path along which the vehicle travels is smaller than the predetermined value. The target speed setting unit 1c may also set the target speed with the allowance smaller than the predetermined allowance for the limit speed when the friction circle of the tire at the point at which the risk cannot be expected easily on the path along which the vehicle travels is smaller than a certain value.

Then, the planned speed pattern generating unit 1d generates the planned speed pattern based on a planned speed (Vx) (km/h) based on the limit speed and the target speed and generates the planned acceleration/deceleration pattern based on planned acceleration/deceleration (Ax) (m/s²), which is the acceleration/deceleration calculated from the planned speed (step SA-4).

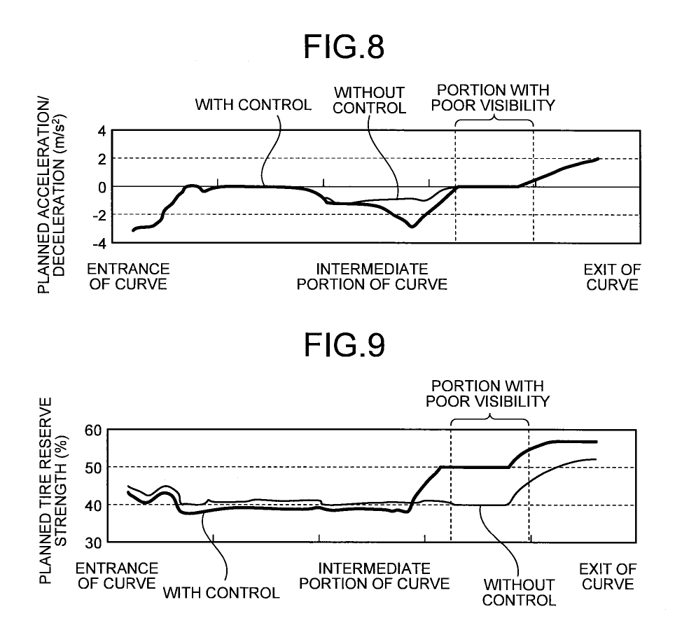

Herein, an example of the planned speed pattern and the planned acceleration/deceleration pattern on the curve on the path along which the vehicle travels is described with reference to FIGS. 7 and 8. FIG. 7 is a view illustrating an example of the planned speed pattern on the curve on the path along which the vehicle travels in this embodiment. FIG. 8 is a view illustrating an example of the planned acceleration/deceleration pattern on the curve on the path along which the vehicle travels in this embodiment.

As illustrated in FIG. 7, in the planned speed pattern (with control), the speed is lower than that in a limit speed pattern (without control) in the portion with poor visibility and around the same located between the intermediate portion to the exit of the curve on the path along which the vehicle travels. On the other hand, in the planned speed pattern (with control), there is a portion in which the speed is slightly higher than that in the limit speed pattern (without control) in the portion with relatively good visibility located between the entrance and the intermediate portion of the curve on the path along which the vehicle travels.

Also, as illustrated in FIG. 8, in the planned acceleration/deceleration pattern (with control), the deceleration is larger than that in a limit acceleration/deceleration pattern (without control) just before the portion with poor visibility located between the intermediate portion and the exit of the curve on the path along which the vehicle travels.

With reference to FIG. 2 again, the planned tire reserve strength calculating unit 1e calculates the tire reserve strength required when the vehicle travels in consideration of the possibility that the unforeseen event is found with delay at the point on the path along which the vehicle travels, the tire reserve strength based on the planned speed (Vx), the planned acceleration/deceleration (Ax), and the planned curvature (K) as the planned tire reserve strength (%) (step SA-5). Herein, the planned tire reserve strength calculating unit 1e may calculate the planned tire reserve strength based on a following equation.

planned tire reserve strength (%)=\sqrt{Aₓ²+Vₓ²*K}

Herein, an example of the planned tire reserve strength pattern on the path along which the vehicle travels in this embodiment is described with reference to FIG. 9. FIG. 9 is a view illustrating an example of the planned tire reserve strength pattern on the path along which the vehicle travels in this embodiment.

As illustrated in FIG. 9, the planned tire reserve strength (with control) is higher than the tire reserve strength (without control) calculated based on the limit speed and the like in the portion with poor visibility and around the same located between the intermediate portion and the exit of the curve on the path along which the vehicle travels.

Meanwhile, the ECU 1 may create the travel plan of the vehicle based on the planned travel line, the planned speed, the planned acceleration/deceleration, and the planned tire reserve strength obtained by the above-described travel plan creating process.

### 3. Summary of This Embodiment

As described above, in this embodiment, the target speed with the predetermined allowance for the limit speed, which is the upper limit speed of the vehicle, is set at the point at which the risk cannot be expected easily on the path along which the vehicle travels and the planned speed pattern, which is the speed pattern of the path, is generated based on the limit speed and the target speed. In other words, in this embodiment, the speed pattern in which the friction circle of the tire is set to be small at the point at which it is highly possible that the unforeseen event is found with delay is generated. According to this, a margin of the tire force at the point at which a dynamic risk is high on the path can be made larger than that at another point and the travel plan with the tire force capable of dealing with the unforeseen event left can be generated.

In this embodiment, when the absolute value of the limit speed at the point at which the risk cannot be expected easily on the path along which the vehicle travels is smaller than the predetermined value, the target speed with the allowance smaller than the predetermined allowance for the limit speed is set. According to this, it is possible to eliminate a sense of discomfort when the vehicle travels at a low speed at the point at which the friction circle of the tire is smaller than the certain value and the margin is sufficient.

In this embodiment, the travel pace of the driver at the time of travel of the vehicle is measured and the average of the friction circle of the tire based on the travel pace is obtained as the travel pace friction circle at the point on the path along which the vehicle travels. According to this, it is possible to create the travel plan close to ordinary travel pace of the driver and with the large margin at the point at which the risk is high. It is possible to assist driving without a sense of discomfort for the driver by allowing the vehicle to travel based on the travel plan.

In this embodiment, when the vehicle speed is higher than the planned speed on the path along which the vehicle travels, the driver is reminded to decelerate. According to this, it is possible to remind the driver when the vehicle travels at the speed higher than the planned speed.

### INDUSTRIAL APPLICABILITY

As described above, the vehicle control device according to the present invention is useful in vehicle manufacturing industry and is especially suitable for executing the travel control of the vehicle by the travel plan based on tire management control technology and the like prepared for the unforeseen event.

### REFERENCE SIGNS LIST

1a ECU

1a TIRE RESERVE STRENGTH SETTING UNIT
1b TRAVEL LINE GENERATING UNIT

1c TARGET SPEED SETTING UNIT

1d PLANNED SPEED PATTERN GENERATING UNIT

1e PLANNED TIRE RESERVE STRENGTH CALCULATING UNIT

1f VEHICLE TRAVEL CONTROLLING UNIT

1g TRAVEL PACE MEASURING UNIT

1h REMINDING UNIT

2 VEHICLE SPEED SENSOR

3 DRIVING FORCE CONTROL MECHANISM

4 OUTPUT DEVICE

1. A vehicle control device, comprising:
a target speed setting unit configured to set a target speed with a predetermined allowance for a limit speed which is an upper limit speed of a vehicle, at a point at which a risk is not expected easily on a path along which the vehicle travels; and
a planned speed pattern generating unit configured to generate a planned speed pattern which is a speed pattern of the path, based on the limit speed and the target speed.

2. The vehicle control device according to claim 1, wherein
the target speed setting unit sets the target speed with the allowance smaller than the predetermined allowance for the limit speed when an absolute value of the limit speed at the point is smaller than a predetermined value.
